(19) United States
(12) Patent Application Publication
(10) Pub. No.: US 2025/0103396 A1
(43) Pub. Date: Mar. 27, 2025

(54) ELECTRONIC DEVICE, LOAD COUNTING METHOD, AND FREQUENCY MODULATION METHOD OF PROCESSOR

(71) Applicant: Smarter Silicon (Shanghai) Technologies Co., Ltd., Shanghai (CN)

(72) Inventors: Guocai YAO, Shanghai (CN); Yupeng SHAN, Shanghai (CN)

(21) Appl. No.: 18/886,342

(22) Filed: Sep. 16, 2024

(30) Foreign Application Priority Data
Sep. 21, 2023 (CN) 202311227712.2

(51) Int. Cl. G06F 9/50

(52) U.S. Cl. CPC G06F 9/505

(57) ABSTRACT

An electronic device includes one or more processors, a load counting hardware structure, and a system memory. The one or more processors are connected to the load counting hardware structure. The one or more processors and the load counting hardware structure are respectively connected to the system memory. The load counting hardware structure is configured to respond to first trigger information to count a first load corresponding to each processor and a second load corresponding to each task in a window period, and update each of the first load and the second load to the system memory.

### CROSS-REFERENCES TO RELATED APPLICATIONS

This application claims priority to Chinese Patent Application No. 202311227712.2, filed on Sep. 21, 2023, the entire content of which is hereby incorporated by reference.

### FIELD OF THE DISCLOSURE

The present disclosure generally relates to the field of electronic technology and, more particularly, relates to an electronic device, a load counting method, and a frequency modulation method of a processor.

### BACKGROUND

In an Android system or a Linux system, loads of a task and a central processing unit (CPU) may be measured through the Watch and Learn Time-lapse (WALT) and the Per-Entity Load Tracing (PELT) algorithms, to balance the loads, and to drive the Dynamic Voltage and Frequency Scaling (DVFS) for adjusting the CPU frequency. The PELT algorithm may lead to a slow load change, which may further lead to slow frequency modulation and poor user experience in interactive scenarios. Implementation of the WALT algorithm may introduce a certain amount of load. When the window becomes smaller, the load overhead introduced by the WALT algorithm may be increased. Currently, the WALT algorithm and the PELT algorithm are each implemented by software, which may introduce a certain amount of CPU overhead. As a result, problems of low computational efficiency and poor computational accuracy may occur.

### SUMMARY

One aspect of the present disclosure includes an electronic device. The electronic device includes one or more processors, a load counting hardware structure, and a system memory. The one or more processors are connected to the load counting hardware structure. The one or more processors and the load counting hardware structure are respectively connected to the system memory. The load counting hardware structure is configured to respond to first trigger information to count a first load corresponding to each processor and a second load corresponding to each task in a window period, and update each of the first load and the second load to the system memory.

Another aspect of the present disclosure provides a load counting method, applicable to an electronic device at least including one or more processors, a load counting hardware structure and a system memory. The load counting hardware structure is configured to execute a load counting method. The load counting method includes: in response to first trigger information, counting a first load corresponding to each processor and a second load corresponding to each task in a window period; and updating each of the first load and the second load to the system memory.

Another aspect of the present disclosure provides a frequency modulation method, applicable to an electronic device. The electronic device at least includes one or more processors, a load counting hardware structure, a system memory, and a dynamic voltage and frequency scaling controller. The dynamic voltage and frequency scaling controller is connected to the load counting hardware structure. The frequency modulation method includes performing load counting by the load counting hardware structure, including: in response to first trigger information, counting a first load corresponding to each processor and a second load corresponding to each task in a window period; and when the first load of a target processor of the one or more processors is determined to be greater than a load threshold, the load counting hardware structure sending a trigger signal to the dynamic voltage and frequency scaling controller, triggering the dynamic voltage and frequency scaling controller to read the first load of the target processor for adjusting a frequency of the target processor.

Other aspects of the present disclosure may be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 illustrates a schematic structural diagram of an electronic device consistent with the disclosed embodiments of the present disclosure.

FIG. 2A illustrates a schematic structural diagram of a load counting hardware structure consistent with the disclosed embodiments of the present disclosure.

FIG. 2B illustrates a flow chart of a load counting method consistent with the disclosed embodiments of the present disclosure.

FIG. 2C illustrates a flow chart of counting a target second load, consistent with the disclosed embodiments of the present disclosure.

FIG. 3A illustrates a flow chart of another load counting method consistent with the disclosed embodiments of the present disclosure.

FIG. 3B illustrates a schematic storage diagram of a load counting hardware structure and a system memory consistent with the disclosed embodiments of the present disclosure.

FIG. 4A illustrates a schematic structural diagram of another electronic device consistent with the disclosed embodiments of the present disclosure.

FIG. 4B illustrates an implementation flow chart of a frequency modulation method of a processor consistent with the disclosed embodiments of the present disclosure.

FIG. 5 illustrates a schematic structural diagram of a load counting device consistent with the disclosed embodiments of the present disclosure.

FIG. 6 illustrates a schematic diagram of a hardware entity of an electronic device consistent with the disclosed embodiments of the present disclosure.

### DETAILED DESCRIPTION

To make the objectives, technical solutions and advantages of the present disclosure clearer and more explicit, the present disclosure is described in further detail with accompanying drawings and embodiments. It should be understood that the specific exemplary embodiments described herein are only for explaining the present disclosure and are not intended to limit the present disclosure.

It should be noted that in the present disclosure, relational terms such as “first” and “second” are only configured to distinguish one entity or operation from another entity or operation, and do not necessarily require or imply that such actual relationship or sequence exists between these entities or operations. Terms “comprise”, “include” or any other variations thereof are intended to cover a non-exclusive inclusion. A process, method, article, or apparatus that includes a series of elements includes not only the series of elements, but also other elements not expressly listed, or elements inherent to such a process, method, article, or apparatus. Without further limitation, an element defined by a statement like “comprises a . . . ” does not exclude the presence of additional identical elements in a process, method, article, or apparatus that includes the foregoing element.

It should be noted that relative arrangements of components and operations, numerical expressions and numerical values set forth in exemplary embodiments are for illustration purpose only and are not intended to limit the present disclosure unless otherwise specified. Techniques, methods and apparatus known to the skilled in the relevant art may not be discussed in detail, but these techniques, methods and apparatus should be considered as a part of the specification, where appropriate.

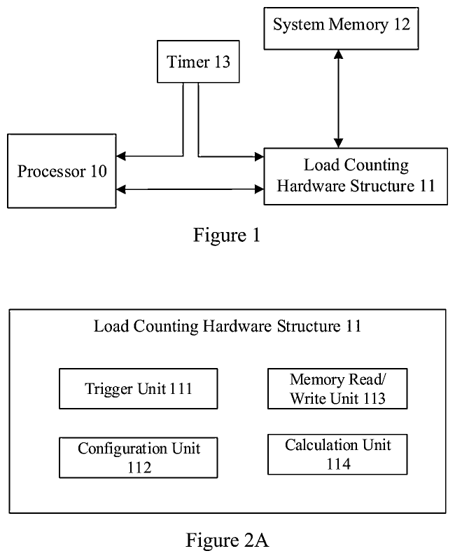

The present disclosure provides an electronic device. FIG. 1 illustrates a schematic structural diagram of an electronic device consistent with the disclosed embodiments of the present disclosure. As shown in FIG. 1, the electronic device at least includes one or more processors 10, a load counting hardware structure 11 and a system memory 12. The processors 10 are connected to the load counting hardware structure 11. The processors 10 and the load counting hardware structure 11 are respectively connected to the system memory 12.

The load counting hardware structure 11 is configured to respond to the first trigger information, count the first load corresponding to each processor and the second load corresponding to each task in a window period, and update each of the first load and the second load to the system memory 12.

In some embodiments, a hardware timer 13 in the electronic device may be multiplexed to trigger the first trigger information. That is, the timer may be periodically used to count the first load and the second load in the window period.

The window period may be set according to counting requirements. Compared with software counting, with hardware implementation, a small counting window may be achieved. For example, when the quantity of central processing unit (CPU) cores is 8, the window period may be set to 4 milliseconds (ms). In this way, the counting window may be set to be small, and the accuracy of load counting may be improved.

The first load refers to the load corresponding to the processor. For example, when the electronic device has an 8-core processor, the load of each processor is counted separately.

During operation, the electronic device may execute a program. That is, the electronic device may perform a series of processes according to instructions and data of the program to complete a specific task. The second load is a load corresponding to the task.

During the implementation process, the second load of each task may be counted first. Then, based on the mapping relationship between the task and the processor running the task, the second load of each task on the processor may be added together to obtain the first load of the processor.

During the implementation process, after the load counting hardware structure performs load counting in the window period, each of the first load and the second load is updated to the system memory. Accordingly, the electronic device may timely obtain the load counting data.

During the implementation process, in cooperation with other hardware units in the electronic device, the logic of the load counting algorithm may be downloaded to the load counting hardware structure for processing. Accordingly, the delay caused by other software logic may be avoided, and the accuracy of update time may be improved. In addition, the Central Processing Unit (CPU) overhead may be reduced, and the concurrency with task scheduling, Dynamic Voltage and Frequency Scaling (DVFS) frequency modulation and other processes may be improved.

In one embodiment, the load counting hardware structure is added to the electronic device to count the first load corresponding to each processor and the second load corresponding to each task in a window period. In this way, using the load counting hardware structure unit to count the processor load and the task load in the window period may reduce the overhead of the load counting on the central processor, and improve the efficiency of load counting. Since the second load corresponding to the task is counted, the accuracy of load counting may be improved.

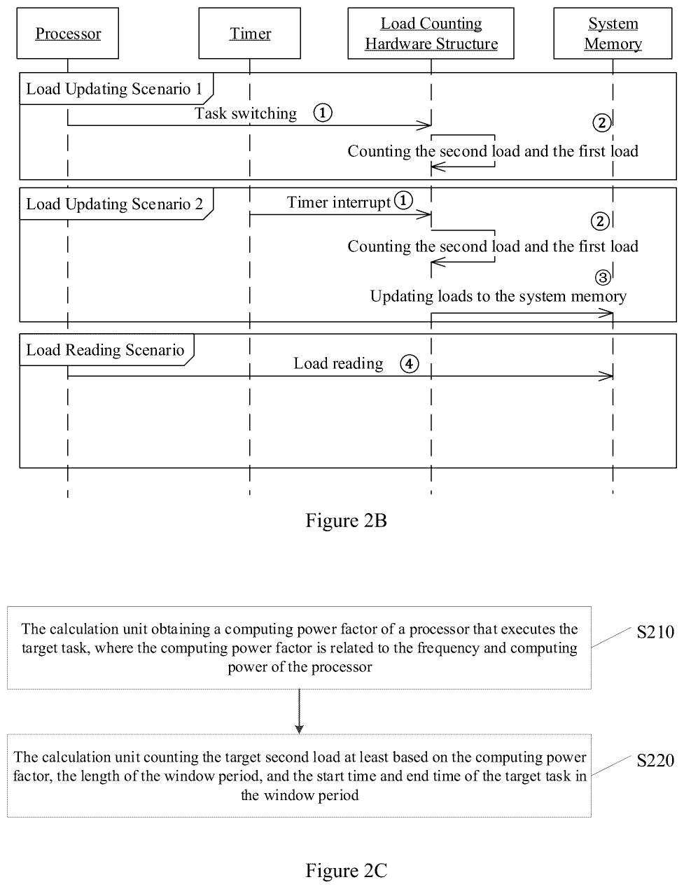

FIG. 2A illustrates a schematic structural diagram of a load counting hardware structure consistent with the disclosed embodiments of the present disclosure. In some embodiments, as shown in FIG. 2A, the load counting hardware structure 11 includes a trigger unit 111, a configuration unit 112, a memory read/write unit (Memory R/W) 113, and a calculation unit 114. The configuration unit 112 is an interface for interaction between the processor and the load counting hardware structure, and is configured to obtain the first trigger information from the processor.

The load counting hardware structure 11 is configured to respond to the first trigger information and count the first load corresponding to each processor and the second load corresponding to each task within the window period. In the load counting hardware structure 11, the trigger unit 111 is configured to receive the first trigger information sent by the configuration unit 112 and generate a corresponding trigger instruction. For example, the trigger unit 111 may be a timer handle unit. The timer handle unit is configured to receive a timer interrupt (the counting window timing time expires), read a timer value, and generate a corresponding trigger instruction based on the timer value.

The configuration unit 112 may include a register (IF). The register may be an interface for the processor to interact with the load counting hardware structure. During the implementation process, the base addresses of the first load and the second load in the system memory, the control that triggers start/stop, and interactive information including process identification (Process Id, PID), processor identification (CPU ID), and update of load results, each may be implemented using the register.

The calculation unit 114 is configured to respond to the trigger instruction, count each of the first load and the second load within a window period, and store each of the first load and the second load in the memory read/write unit 113.

The memory read/write unit 113 is configured to update each of the first load and the second load to the system memory with the window period as the update period. For example, the memory read/write unit may be configured to store, read and write the load data.

In one embodiment, a trigger unit, a configuration unit, a memory read/write unit and a calculation unit may be set in the load counting hardware structure. Each of the first load and the second load may be counted, and the counting results may be updated to the system memory in time with the window period as the update period.

In some embodiments, the memory read/write unit is configured to update each of the first load and the second load to the system memory. Specifically, the memory read/write unit is configured to respond to the first trigger information or the second trigger information, store each of the first load and the second load in a last window period into the system memory, and clear the memory read/write unit. The second trigger information is configured to trigger the counting end of the window period.

In some embodiments, the second trigger information may be different from the first trigger information. That is, the second trigger information and the first trigger information may occur at different time points. The first trigger information is configured to trigger the start of counting during the window period, and the second trigger information is configured to trigger the end of counting during the window period. For example, at the end of the window period, that is, based on the second trigger information, the first load and the second load may be stored in the system memory, and the memory read/write unit may be cleared.

In some embodiments, the second trigger information and the first trigger information may occur at a same time point. That is, the start time of a next window period is the end time of a last window period. For example, at the start time of the next window period, that is, based on the first trigger information, the first load and the second load may be stored to the system memory, and the memory read/write unit may be cleared.

During the implementation process, the load counting hardware structure may only store the cache load data (the first load and the second load) during the window period. After each window period arrives, the load data may be saved to a corresponding location in the system memory, the internal load data may be cleared, and new counting data may be recorded.

In one embodiment, in response to the first trigger information or the second trigger information, each of the first load and the second load in the last window period is stored in the system memory, and the memory read/write unit is cleared. In this way, the load data in the load counting hardware structure may be cleared in time, such that there is storage space for storing the load data counted after the load counting hardware structure is cleared.

The present disclosure provides a load counting method. FIG. 2B illustrates a flow chart of a load counting method consistent with the disclosed embodiments of the present disclosure. As shown in FIG. 2B, the load counting method includes three scenarios: load updating scenario 1, load updating scenario 2, and load reading scenario.

The load updating scenario 1 may include [symbol] task switching and [symbol] load counting. In the [symbol] task switching, the load counting hardware structure receives the task switching information sent by the processor, and triggers the [symbol] load counting. In the [symbol] load counting, the load counting hardware structure calculates the task load (second load) according to the following Equation (3), and adds the task load to the corresponding CPU load (first load). The results may be temporarily stored in the internal cache (buffer) of the load counting hardware structure. The internal cache may be located in the memory read/write unit 113 in the load counting hardware structure (refer to FIG. 2A).

The present disclosure provides a task load normalization calculation method. The calculation method is applicable to mobile platforms, and may be used for obtaining the normalized task/CPU load. Considering the impact of CPU cores with different computing power and different frequencies, the task load may be calculated with the following Equation (1):

$$Taskload = ( Freqavg / Freq max ) * ( Capacitycur\_cpu / Capacity max ) * ( Stop\_time - Start\_time ) * 1024 / window \qquad ( 1 )$$

where (Freqavg/Freqmax) is the frequency factor. Considering the impact of different CPU frequencies, running at different frequencies in a same period of time may generate different loads. The load is normalized to the highest frequency Freqmax of the largest core. (Capacitycur_cpu/Capacitymax) is the computing power factor. Considering the impact of computing power, the loads generated by running on different CPU computing cores in a same period of time may be different, and the load is normalized to the CPU core with the highest computing power. Window is the counting window time (unit: ms). The number 1024 is the full load when the largest core runs at the highest frequency for the entire counting window time.

In the present disclosure, hardware is configured to perform complex counting. Compared with software, the counting window may be small. Compared with existing technology, factors to be considered may be reduced. The load counting obtained by only considering the computing power and frequency may be accurate and the calculation process may be simplified. In addition, by setting a small counting window, the accuracy of load counting may be improved.

During the implementation process, to simplify the hardware calculation unit, a computing power factor table is introduced. The computing power factor may be generated according to the CPU information during initialization. The window size is a power of 2. In this way, the above Equation (1) may be converted into a multiplication calculation, an addition operation and a shift operation. The following Equation (2) is a calculation equation for the computing power factor, and Equation (3) is the calculation equation for the task load after Equation (1) is simplified:

$$Computing Power Factor = ( Freqavg / Freq max ) * ( Capacitycur\_cpu / Capacity max ) \qquad ( 2 )$$

$$Taskload = Computing power factor * ( Stop\_time - Start\_time ) * 1024 / window \qquad ( 3 )$$

Table 1 shows examples of the corresponding computing power and maximum frequency of processors with different cores (super core, large core, small core):

TABLE 1

| Cores | Computing Power | Maximum Frequency |
|---|---|---|
| Small core | 280 | 2016000 |
| Large core | 855 | 2803200 |
| Super core | 1024 | 2956800 |

Table 2 shows examples of the computing power factors (1 super core+3 large cores+4 small cores).

TABLE 2

| CPU | Frequency | | Computing |
|---|---|---|---|
| Index | Index | Frequency | Power Factor |
| 0 | 0 | 307200 | 0.0417 |
| 0 | 1 | 441600 | 0.0599 |
| 0 | 2 | 556800 | 0.0755 |
| 0 | . . . | . . . | . . . |
| 0 | . . . | 2016000 | 0.2734 |
| 3 | . . . | 499200 | 0.1487 |
| 3 | . . . | 614400 | 0.1830 |
| 3 | . . . | 729600 | 0.2173 |
| 3 | . . . | . . . | . . . |
| 3 | . . . | 2323200 | 0.6920 |
| 3 | . . . | 2707200 | 0.8064 |
| 3 | . . . | 2803200 | 0.8350 |
| 7 | . . . | 595200 | 0.2013 |
| 7 | . . . | 729600 | 0.2468 |
| 7 | . . . | 864000 | 0.2922 |
| 7 | . . . | . . . | . . . |
| 7 | . . . | 2476800 | 0.8377 |
| 7 | . . . | 2841600 | 0.9610 |
| 7 | . . . (Continuous number) | 2956800 | 1.0000 |

From Table 2, the computing power factors corresponding to CPUs at different frequencies may be obtained. CPU Index is the identifier corresponding to processors with different computing powers. Corresponding computing power factors may be obtained for processors with different computing powers and at different frequencies. For example, the processor identified as 0 is the small-core processor in Table 1, the processor identified as 3 is the large-core processor in Table 1, and the processor identified as 7 is the super-core processor in Table 1.

The load updating scenario 2 includes [symbol] timer interrupt, [symbol] load counting, and [symbol] 10 load updating. In the [symbol] timer interrupt, the load counting hardware structure receives the timer interrupt (indicating that the counting window time expires), and triggers the [symbol] load counting and the [symbol] load updating. In the [symbol] load counting, the load counting hardware structure calculates the task load according to Equation (1), adds the task load to the corresponding CPU load, and temporarily stores the result in the internal buffer of the load counting hardware structure. In the [symbol] load updating, the load counting hardware structure updates the internal buffer content to the corresponding system memory and starts a new round of load counting.

The load reading scenario includes [symbol] load reading. In the [symbol] load reading, the CPU reads the load data in the system memory to obtain the first load and the second load in the window period. In some embodiments, the calculation unit is configured to count each of the first load and the second load in the window period. Specifically, the first load and the second load may be counted in Process A and Process B.

Process A: in the window period, in response to task switching information, the calculation unit triggers task load counting, to respectively count the second load corresponding to each task that has been switched.

Referring to the load updating scenario 2 as shown in FIG. 2B, in the window period, when task switching information is received, task load counting is triggered to count the second load corresponding to each task that has been switched. For example, during the window period, the first-stage task A being executed may be switched to task B, and then switched back to the second-stage task A. Then, the load of task A in the first stage, the load of task B, and the load of task A in the second stage may be counted. That is, the second load of each task in the window period may be counted.

Process B: in response to the second trigger information, the load calculation unit accumulates the second loads corresponding to each of the processors to obtain each of the first loads. The second trigger information may be information about the end of the window period or information about the start of a next window period.

During the implementation process, the task corresponding to each processor may be determined according to the mapping relationship between the processor and the task executed by the processor. By accumulating each second load of the processor, the first load of the processor may be obtained.

In one embodiment, in the window period, in response to task switching information, the calculation unit may trigger task load counting to respectively count the second load corresponding to each task that has been switched. In response to the second trigger information, the load calculation unit accumulates each of the second loads corresponding to each of the processors to obtain each of the first loads. In this way, the first load corresponding to each of the tasks operating in the window period may be counted. At the end of the window period, each of the second loads corresponding to each processor may be accumulated to obtain each of the first loads. The second load obtained by the second load counting may be accumulated to obtain the first load, and may also be used to schedule tasks. When scheduling tasks, the tasks may be allocated to matching CPU cores according to the values of the second loads corresponding to different tasks. As such, the task processing efficiency may be improved.

FIG. 2C illustrates a flow chart of counting a target second load, consistent with the disclosed embodiments of the present disclosure. In some embodiments, as shown in FIG. 2C, the target second load in window period may be obtained by S210 and S220. The target second load is the load corresponding to the target task.

S210: Using the calculation unit to obtain a computing power factor of a processor that executes the target task, where the computing power factor is related to the frequency and computing power of the processor.

In the implementation process, the computing power factor may be calculated using the following Equation (2):

$$Computing Power Factor = ( Freqavg / Freq max ) * ( Capacitycur\_cpu / Capacity max ) \qquad ( 2 )$$

where (Freqavg/Freqmax) is the frequency factor. Considering the impact of different CPU frequencies, running at different frequencies for a same period of time may generate different loads. The frequency is normalized to the highest frequency Freqmax of the largest core. (Capacitycur_cpu/Capacitymax) is the computing power factor. Considering the impact of computing power, the load generated by running on different CPU computing cores at a same period of time may be different. The load is normalized to the CPU core with the highest computing power.

Table 2 above tabulates examples of the computing power factors. In the implementation process, the computing power factors of different processors at different frequencies may be pre-calculated and stored. When calculating the second load, the second load may be directly retrieved from the stored computing power factor table.

For example, the configuration unit 112 in FIG. 2A may read the pre-calculated computing power factors of different processors at different frequencies from the system memory. The computing power factor is then sent to the calculation unit 114 such that the computing power factor may be used by the calculation unit 114 to calculate the second load.

S220: Using the calculation unit to count the target second load at least based on the computing power factor, the length of the window period, and the start time and end time of the target task in the window period.

During the implementation process, the target second load may be calculated using the following Equation (3):

$$Taskload = Computing power factor * ( Stop\_time - Start\_time ) * 1024 / window \qquad ( 3 )$$

where Window is the counting window time (in milliseconds, ms). Number 1024 is the full load when the largest core runs the entire counting window time at the highest frequency.

In one embodiment, the calculation unit may obtain the computing power factor of the processor executing the target task. The target second load may be counted at least based on the computing power factor, the duration of the window period, and the start time and end time of the target task in the window period. In this way, the computing power factor is pre-calculated, and then the computing power factor is used to calculate the second load. Accordingly, the second load may be obtained, and the efficiency of calculating the second load may be improved.

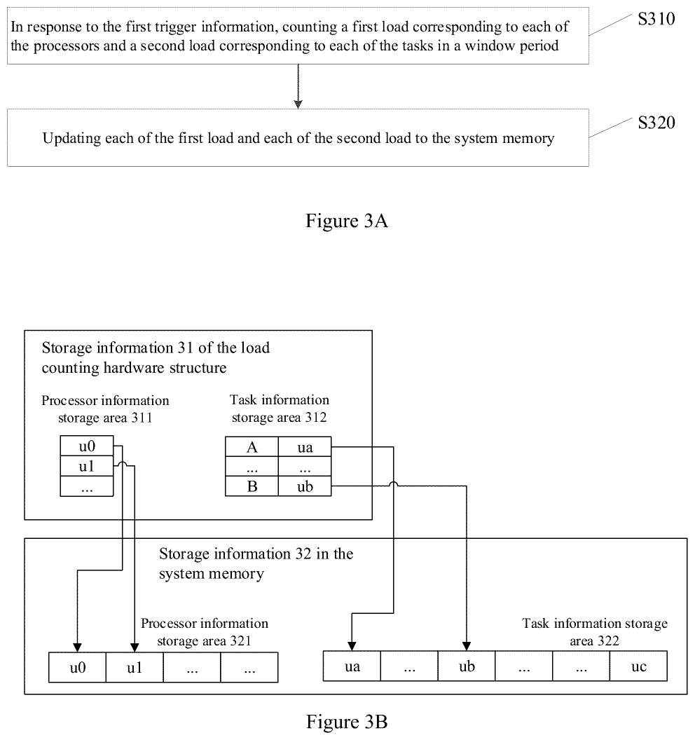

FIG. 3A illustrates a flow chart of another load counting method consistent with the disclosed embodiments of the present disclosure. The load counting method may be applied to an electronic device at least including a processor, a load counting hardware structure and a system memory. As shown in FIG. 3A, the load counting method may be executed by using the load counting hardware structure, and the load counting method includes S310 and S320.

S310: in response to the first trigger information, counting a first load corresponding to each of the processors and a second load corresponding to each task in a window period.

S320: updating each of the first load and the second load to the system memory.

In one embodiment, the load counting hardware structure is configured to respond to the first trigger information, and count the first load corresponding to each of the processors and the second load corresponding to each task in the window period. Each of the first load and the second load is updated to the system memory. In this way, the overhead of counting load on the central processor may be reduced, and the efficiency of load counting may be improved. Since the second load corresponding to the task is counted, the accuracy of load counting may be improved.

FIG. 3B illustrates a schematic storage diagram of a load counting hardware structure and a system memory consistent with the disclosed embodiments of the present disclosure. As shown in FIG. 3B, the schematic storage diagram includes the storage information 31 of the load counting hardware structure and the storage information 32 in the system memory. The storage information 31 of the load counting hardware structure includes the first load corresponding to the storage processor stored in the processor information storage area 311, and the task identifiers and the second load corresponding to each task identifier stored in the task information storage area 312. The processor information storage area 311 and the task information storage area 312 each are located in the memory read/write unit 113 as shown in FIG. 2A.

For example, when the quantity of CPU cores is 8 and the window size is 4 ms, 384B of memory may be added inside the load counting hardware structure.
a) The load counting hardware structure only stores cache load data during the window period. After each window period arrives, the load information is saved as storage information 32 to a corresponding position in the system memory. That is, the first load is stored in the processor information storage area 321, and the second load is stored in the task information storage area 322. The internal load (the storage information 31 of the load counting hardware structure) is cleared for recording new counting data.
b) The quantity of CPU load information is consistent with the quantity of the CPUs. During initialization, the data format is specified as u64, and the size is 64B for 8 CPUs.
c) The data size of the task load (the second load) information is related to the quantity of CPUs and the counting window size which may be specified during initialization. For example, the quantity of CPUs is 8, the window period is 4 ms. When it is determined that that only loads greater than 1 ms are worth counting, a single CPU needs to count at most 4 tasks in a window period, and the quantity of data for task load information is 4*8=32B. Each data includes a u32 task identifier and a u64 load, so the size of a task data is u32+u64=12B. As such, the overall storage size requirement is 32*12B-384B. The task identifier may be used to determine the location in the task information storage area 312. As shown in FIG. 3B, the task identifier is A, and the load ua is stored in the corresponding column and managed in the CPU software. The mapping relationship between storage information and addresses may be established based on physical address allocation, or the corresponding relationship may be established through the logical address corresponding to the physical address.

The storage information 32 in the system memory includes the first load stored in the processor information storage area 321 and the second load stored in the task information storage area 322.
a) The CPU software initializes the number and base address, and passes the number and base address to the load counting hardware structure. When updating the window, the load counting hardware structure updates the first load information stored in the processor information storage area 311 to the corresponding column of the processor information storage area 321 in the system memory.
b) The CPU software initializes the number and base address, and passes the number and base address to the load counting hardware structure. When a task starts operation, the software allocates a task identifier and transmits the task identifier to the load counting hardware structure (such as identifiers A and B in the task information storage area 312 shown in FIG. 3B). When updating the window, the load counting hardware structure updates the second load information corresponding to the task to the corresponding task unit column. For example, as shown in FIG. 3B, the column ua corresponding to the identifier A and the column ub corresponding to the identifier B in the task information storage area 312.

In some embodiments, the system memory may save about 1 MB. That is, the load counting method may not increase system memory.

In some embodiments, the process S320 “updating each of the first load and the second load to the system memory” may be implemented by the following operations: in response to the first trigger information or the second trigger information, storing each of the first load and the second load in the last window period into the system memory, and clearing the memory read/write unit. The second trigger information is configured to trigger the end of counting of the window period.

In one embodiment, the load counting hardware structure only stores the cache load data (the first load and the second load) in the window period. Each time when a window period ends or a new window period arrives, the load data is saved to a corresponding location in the system memory, and the internal load is cleared for recording new counting data. In this way, the load data in the load counting hardware structure may be cleared in time, such that there is sufficient storage space for storing the load data counted subsequently.

In some embodiments, the process S320 “updating each of the first load and the second load to the system memory” may be implemented by S321 and S322.

S321: in response to the task switching information, triggering task load counting to respectively count the second load corresponding to each task that has been switched.

S322: in response to the second trigger information, accumulating each of the second loads corresponding to each of the processors to obtain each of the first loads.

In one embodiment, in the window period, in response to task switching information, the calculation unit may trigger task load counting to respectively count the second load corresponding to each task that has been switched. In response to the second trigger information, the load calculation unit may accumulate each of the second loads corresponding to each of the processors to obtain each of the first loads. In this way, the first load corresponding to each of the tasks operating in the window period may be counted. At the end of the window period, each of the second loads corresponding to each processor may be accumulated to obtain each of the first loads.

In some embodiments, the process of counting the target second load in the window period includes S210 and S220, where the target second load is the load corresponding to the target task.

S210: obtaining the computing power factor of the processor that executes the target task, where the computing power factor is related to the frequency and computing power of the processor. During the implementation process, the computing power factor may be calculated using the above Equation (2). The computing power factor of the processor of the target task may be calculated in real time. It is also possible to pre-calculate and store the computing power factors of different processors at different frequencies, and then obtain the computing power factor of the processor that executes the target task from the pre-calculated and stored computing power factors.

S220: counting the target second load at least based on the computing power factor, the duration of the window period, and the start time and end time of the target task in the window period. During the implementation process, the target second load may be calculated using the above Equation (3).

In one embodiment, the computing power factor of the processor executing the target task may be first obtained. Then, the target second load may be counted at least based on the computing power factor, the duration of the window period, and the start time and end time of the target task in the window period. In this way, by pre-calculating the computing power factor and then using the computing power factor to calculate the second load, the second load may be obtained, and the efficiency of calculating the second load may be improved.

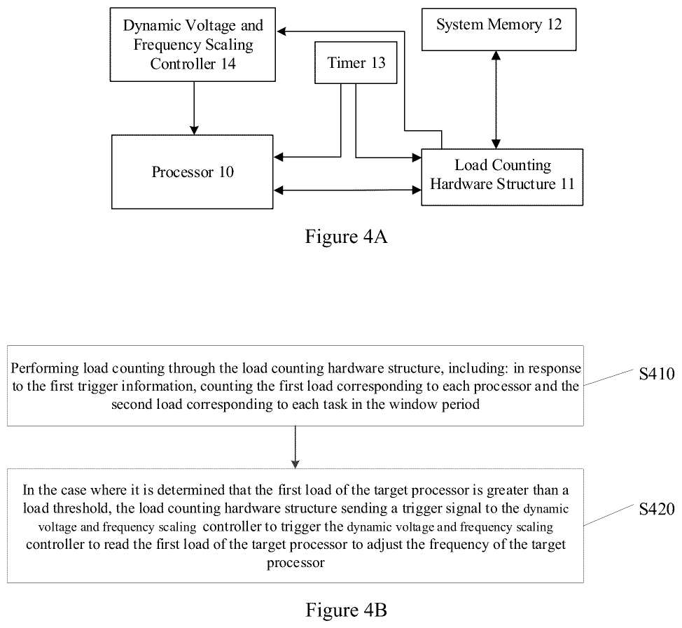

FIG. 4A illustrates a schematic structural diagram of another electronic device consistent with the disclosed embodiments of the present disclosure. As shown in FIG. 4A, in one embodiment, the electronic device at least includes a processor 10, a load counting hardware structure 11, a system memory 12, and a dynamic voltage and frequency scaling (DVFS) controller 14. The DVFS controller 14 is connected to the load counting hardware structure 11.

The present disclosure provides a frequency modulation method of a processor, which may be applied to the electronic device shown in FIG. 4A. FIG. 4B illustrates an implementation flow chart of a frequency modulation method of a processor consistent with the disclosed embodiments of the present disclosure. As shown in FIG. 4B, the method includes S410 and S420.

S410: performing load counting through the load counting hardware structure, including: in response to the first trigger information, counting the first load corresponding to each processor and the second load corresponding to each task in the window period.

S420: in the case where it is determined that the first load of the target processor is greater than a load threshold, the load counting hardware structure sending a trigger signal to the DVFS controller to trigger the DVFS controller to read the first load of the target processor to adjust the frequency of the target processor.

The DVFS controller may perform dynamic voltage and frequency adjustment. The DVFS controller may dynamically adjust the operating frequency and voltage of the processor, according to different computing power requirements of the tasks operating on the processor. For example, for a same processor, the higher the frequency, the higher the required voltage. By adjusting the frequency and voltage, energy saving may be achieved.

During the implementation process, the load counting hardware structure may notify the DVFS controller when the first load increases and exceeds the load threshold. The DVFS controller may read corresponding first load information from the system memory and adjust the corresponding target processor based on the first load.

In one embodiment, when the load counting hardware structure determines that the first load of the target processor is greater than a load threshold, a trigger signal may be sent to the DVFS controller to adjust the frequency of the target processor in time. Accordingly, task operation problems caused by the processor being unable to handle tasks in a timely manner due to excessive load may be addressed.

The present disclosure also provides a load counting device. The device includes modules. Each module includes submodules, and each submodule includes units. The modules, submodules and units each may be implemented by the processor in the electronic device, and may also be implemented through specific logic circuits. During the implementation process, the processor may be a central processing unit (CPU), a microprocessor (MPU), a digital signal processor (DSP), or a field programmable gate array (FPGA).

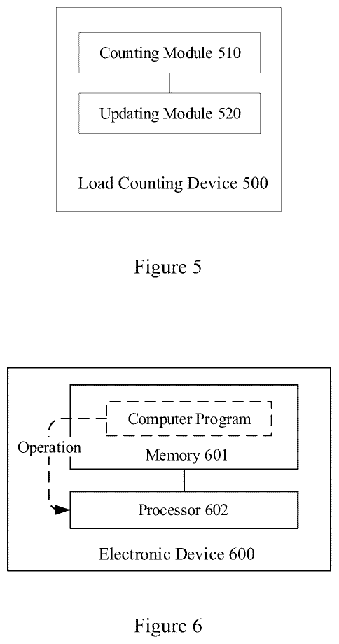

FIG. 5 illustrates a schematic structural diagram of a load counting device consistent with the disclosed embodiments of the present disclosure. As shown in FIG. 5, the load counting device 500 includes a counting module 510 and an updating module 520. The counting module 510 is configured to respond to the first trigger information and calculate a first load corresponding to each processor and a second load corresponding to each task in a window period. The updating module 520 is configured to update each of the first load and the second load to the system memory.

In some embodiments, the updating module 520 is also configured to, in response to the first trigger information or the second trigger information, store each of the first load and the second load in a last window period into the system memory, and clear the memory read/write unit. The second trigger information may be used to trigger the end of counting in the window period.

In some embodiments, the updating module includes a counting submodule and an accumulation submodule. The counting submodule is configured to trigger task load counting in response to task switching information, so as to respectively count the second load corresponding to each task that has been switched. The accumulation submodule is configured to, in response to the second trigger information, accumulate each of the second loads corresponding to each of the processors to obtain each of the first loads.

In some embodiments, the counting submodule includes an acquisition unit and a counting unit. The acquisition unit is configured to acquire the computing power factor of the processor executing the target task. The computing power factor is related to the frequency and computing power of the processor. The counting unit is configured to count the target second load at least based on the computing power factor, the duration of the window period, and the start time and end time of the target task in the window period.

For implementation details and beneficial effects of the load counting device, reference may be made to the descriptions of the load counting method in the present disclosure, which will not be elaborated here.

It should be noted that, in the present disclosure, when the load counting method is implemented in the form of a software functional module and sold or used as an independent product, the method may also be stored in a computer-readable storage medium. Based on this understanding, the essential technical solution of the present disclosure, or the part that contributes to the relevant technology, may be implemented in the form of a computer software product. The software product may be stored in a storage medium, and may include a plurality of instructions for making an electronic device (which may be a mobile phone, tablet computer, laptop computer, desktop computer, etc.) to execute each or part of the methods provided by the present disclosure. The storage medium may include U disk, mobile hard disk, read only memory (ROM), magnetic disk, optical disk, and other media that may store program code. The present disclosure does not limit any specific combination of hardware and software.

Correspondingly, the present disclosure provides a storage medium on which a computer program is stored. When the computer program is executed by a processor, the processes of the load counting method provided by the present disclosure may be implemented.

Correspondingly, the present disclosure provides an electronic device. FIG. 6 illustrates a schematic diagram of a hardware entity of an electronic device consistent with the disclosed embodiments of the present disclosure. As shown in FIG. 6, the hardware entity of the electronic device 600 includes a memory 601 and a processor 602. The memory 601 stores a computer program that may be executed by the processor 602. When the processor 602 executes the computer program, the processes in the load counting method provided by the present disclosure may be implemented.

The memory 601 is configured to store instructions and applications executable by the processor 602. The memory 601 may also cache data (for example, image data, audio data, voice communication data, and video communication data) to be processed or processed by the processor 602 and each module in the electronic device 600. The memory 601 may be implemented through flash memory (FLASH) or random access memory (RAM).

For implementation details and beneficial effects of the storage medium and the electronic device, reference may be made to the descriptions of the load counting method in the present disclosure, which will not be elaborated here.

In the present disclosure, the embodiments described are merely illustrative. It should be understood that the disclosed devices and methods may be implemented in other ways. For example, the unit division is only a logical function division, and there may be other division methods in actual implementation. A plurality of units or components may be combined, or may be integrated into another system, and some features may be ignored or not performed. In addition, the coupling, direct coupling, or communication connection between the components may be achieved through interfaces, indirect couplings or communication connections of devices, components or units. The interfaces, indirect couplings or communication connections may be electrical, mechanical or other forms.

In the present disclosure, the units described as separate components may or may not be physically separate, and the components shown as units may or may not be physical units. The components and units may be located in one place or distributed across a plurality of network units. Each or a part of the components and units may be selected according to actual needs to achieve the purposes of the present disclosure.

In addition, each of the functional units in an embodiment of the present disclosure may be integrated into one processing unit, or each functional unit may separately operate as a processing unit, or two or more functional units may be integrated into one processing unit. The integrated processing unit may be implemented in the form of hardware, or in the form of hardware plus software functional units.

Those skilled in the art may understand that, each or part of the processes of the method provided by the present disclosure may be completed by hardware related to program instructions. The program may be stored in a computer-readable storage medium. When the program is executed, the processes of the method may be performed. The storage medium may include a mobile storage device, read-only memory (ROM), magnetic disk or optical disk, and other media that may store program codes.

When the integrated unit of the present disclosure is implemented in the form of a software function module and sold or used as an independent product, the integrated unit may also be stored in a computer-readable storage medium. Based on this understanding, the technical solution of the present disclosure, or the part that contributes to the relevant technology, may essentially be embodied in the form of a software product. The computer software product may be stored in a storage medium, and may include a plurality of instructions. The plurality of instructions may make an electronic device (which may be a mobile phone, tablet computer, laptop computer, desktop computer, etc.) to execute each or part of the methods provided by the present disclosure. The storage medium may include a mobile storage device, ROM, magnetic disk, optical disk, and other medium that may store program codes.

In the absence of conflict, the methods disclosed in the method embodiments of the present disclosure may be combined arbitrarily to obtain new method embodiments.

In the absence of conflict, the features disclosed in the product embodiments of the present disclosure may be arbitrarily combined to obtain new product embodiments.

In the absence of conflict, the features disclosed in the method embodiments or device embodiments of the present disclosure may be arbitrarily combined to obtain new method embodiments or device embodiments.

As disclosed, the technical solutions of the present disclosure have the following advantages.

In the present disclosure, the load counting hardware structure may be added to the electronic device to count the first load corresponding to each processor and the second load corresponding to each task in a window period. In this way, by using the load counting hardware structure unit to count the processor load and task load in the window period, the overhead of load counting on the central processor may be reduced, and the load counting efficiency may be improved. Since the second load corresponding to the task is counted, the accuracy of load counting may be improved.

The embodiments disclosed in the present disclosure are exemplary only and not limiting the scope of the present disclosure. Various combinations, alternations, modifications, or equivalents to the technical solutions of the disclosed embodiments may be obvious to those skilled in the art and may be included in the present disclosure. Without departing from the spirit of the present disclosure, the technical solutions of the present disclosure may be implemented by other embodiments, and such other embodiments are intended to be encompassed within the scope of the present disclosure.

What is claimed is:

1. An electronic device, comprising:
one or more processors, a load counting hardware structure, and a system memory,
wherein:
the one or more processors are connected to the load counting hardware structure;
the one or more processors and the load counting hardware structure are respectively connected to the system memory; and
the load counting hardware structure is configured to respond to first trigger information to count a first load corresponding to each processor and a second load corresponding to each task in a window period, and update each of the first load and the second load to the system memory.

2. The electronic device according to claim 1, wherein the load counting hardware structure includes a trigger unit, a configuration unit, a memory read/write unit, and a calculation unit, wherein:
the configuration unit is an interface for interaction between the processor and the load counting hardware structure, and is configured to obtain the first trigger information from the processor;
the trigger unit is configured to receive the first trigger information sent by the configuration unit and generate a trigger instruction corresponding to the first trigger information;
the calculation unit is configured to respond to the trigger instruction, count each of the first load and the second load in the window period, and store each of the first load and the second load in the memory read/write unit; and
the memory read/write unit is configured to update each of the first load and the second load to the system memory using the window period as an update period.

3. The electronic device according to claim 2, wherein:
the memory read/write unit is configured to respond to the first trigger information or second trigger information to store each of the first load and the second load in a last window period into the system memory, and clear the memory read/write unit, wherein the second trigger information is configured to trigger a counting end of the window period.

4. The electronic device according to claim 3, wherein:
the second trigger information and the first trigger information occur at different time points, wherein the first trigger information is configured to trigger a start of counting in the window period, and the second trigger information is configured to trigger an end of counting in the window period.

5. The electronic device according to claim 3, wherein:
the second trigger information and the first trigger information occur at a same time point, wherein a start time of a next window period is an end time of a last window period.

6. The electronic device according to claim 3, wherein:
in the window period, in response to task switching information, the calculation unit is configured to trigger a task load counting, to respectively count the second load corresponding to each task that is switched; and
in response to the second trigger information, the calculation unit is configured to accumulate the second load corresponding to each processor to obtain each first load.

7. The electronic device according to claim 6, wherein:
the task is allocated to a matching CPU core of the processor according to a value of the second load corresponding to the task.

8. The electronic device according to claim 6, wherein
the calculation unit is configured to count a target second load in the window period, wherein the target second load is a load corresponding to a target task,
the calculation unit is further configured to obtain a computing power factor of a processor that executes the target task, wherein the computing power factor is related to a frequency and computing power of the processor; and count the target second load at least based on the computing power factor, a length of the window period, and a start time and an end time of the target task in the window period.

9. The electronic device according to claim 1, further comprising a dynamic voltage and frequency scaling controller, wherein:
the dynamic voltage and frequency scaling controller is connected to the load counting hardware structure; and
the dynamic voltage and frequency scaling controller is configured to dynamically adjust an operating frequency and a voltage of the processor.

10. A load counting method, applicable to an electronic device at least including one or more processors, a load counting hardware structure and a system memory, wherein:
the load counting hardware structure is configured to execute a load counting method; and
the load counting method includes:
in response to first trigger information, counting a first load corresponding to each processor and a second load corresponding to each task in a window period; and
updating each of the first load and the second load to the system memory.

11. The method according to claim 10, wherein updating each of the first load and the second load to the system memory includes:
in response to the first trigger information or second trigger information, storing each of the first load and the second load in a last window period of the window period into the system memory, and clearing a memory read/write unit of the load counting hardware structure, wherein the second trigger information is configured to trigger an end of counting in the window period.

12. The method according to claim 11, wherein counting each of the first load and the second load in the window period includes:
in response to task switching information, triggering task load counting to respectively count the second load corresponding to each task that is switched; and
in response to the second trigger information, accumulating each second load corresponding to each processor to obtain each first load.

13. The method according to claim 12, further comprising: counting a target second load corresponding to a target task in the window period, by performing:
obtaining a computing power factor of a processor that executes the target task, wherein the computing power factor is related to a frequency and computing power of the processor; and
counting the target second load at least based on the computing power factor, a length of the window period, and a start time and an end time of the target task in the window period.

14. A frequency modulation method, applicable to an electronic device, wherein the electronic device at least includes one or more processors, a load counting hardware structure, a system memory, and a dynamic voltage and frequency scaling controller, wherein the dynamic voltage and frequency scaling controller is connected to the load counting hardware structure,
the frequency modulation method comprising:
performing load counting by the load counting hardware structure, including: in response to first trigger information, counting a first load corresponding to each processor and a second load corresponding to each task in a window period; and
when the first load of a target processor of the one or more processors is determined to be greater than a load threshold, the load counting hardware structure sending a trigger signal to the dynamic voltage and frequency scaling controller, triggering the dynamic voltage and frequency scaling controller to read the first load of the target processor for adjusting a frequency of the target processor.

15. The method according to claim 14, wherein:
the dynamic voltage and frequency scaling controller is configured to adjust an operating frequency and a voltage of the processor, according to a computing power requirement of the task operating on the processor.

16. The method according to claim 14, wherein:
the load counting hardware structure is implemented by a logic circuit.

17. The method according to claim 14, wherein the load counting hardware structure includes a counting module and an updating module, wherein:
the counting module is configured to respond to the first trigger information and calculate a first load corresponding to each processor and a second load corresponding to each task in the window period; and
the updating module is configured to update each of the first load and the second load to the system memory.

18. The method according to claim 17, wherein:
the updating module is further configured to, in response to the first trigger information or second trigger information, store each of the first load and the second load of a last window period into the system memory, and clear the memory read/write unit of the load counting hardware structure, wherein the second trigger information is configured to trigger an end of counting in the window period.

19. The method according to claim 18, wherein the updating module includes a counting submodule and an accumulation submodule, wherein:
the counting submodule is configured to trigger task load counting in response to task switching information, to respectively count the second load corresponding to each task that is switched; and
the accumulation submodule is configured to, in response to the second trigger information, accumulate each second load corresponding to each processor to obtain each first load.

20. The method according to claim 19, wherein the counting submodule includes an acquisition unit and a counting unit, wherein:
the acquisition unit is configured to acquire a computing power factor of the processor executing a target task, wherein the computing power factor is related to a frequency and computing power of the processor; and
the counting unit is configured to count a target second load at least based on the computing power factor, a duration of the window period, and a start time and an end time of the target task in the window period.
